(19) United States
(12) Patent Application Publication
(10) Pub. No.: US 2026/0244945 A1
(43) Pub. Date: Aug. 20, 2026

(54) DATA ANALYSIS MODEL PREDICTION ADJUSTMENT USING SCALAR FACTORS

(71) Applicant: Capital One Services, LLC, McLean, VA (US)

(72) Inventors: Sreekanth CHINTHAGUNTA, Mckinney, TX (US); Vikas YADAV, Frisco, TX (US); Saranya THANGARAJ, Frisco, TX (US); Bing LIU, Frisco, TX (US); John LUJANO, Dallas, TX (US)

(21) Appl. No.: 19/058,808

(22) Filed: Feb. 20, 2025

(51) Int. Cl. G06N 5/01

(52) U.S. Cl. CPC G06N 5/01

(57) ABSTRACT

In some implementations, a data analysis system may detect a performance gap associated with the data analysis model. The data analysis system may generate a model adjustment factor for the data analysis model based on the performance gap associated with the data analysis model, wherein the model adjustment factor is a scalar value applicable to one or more predictions associated with the data analysis model. The data analysis system may generate a data file for the data analysis model based on the model adjustment factor. The data analysis system may execute the data analysis model with the data file to generate a third dataset of predictions associated with the data analysis model. The data analysis system may output information associated with the third set of predictions.

### BACKGROUND

Machine learning model training, re-training, and usage involve the application of computational algorithms to process input data and generate predictive outputs. Training employs labeled or unlabeled datasets to optimize model parameters through iterative adjustments, minimizing error functions, and enhancing accuracy. Re-training updates model parameters using new or augmented datasets to maintain performance and adapt to evolving data distributions. Usage applies trained models to infer results from real-world inputs, leveraging learned representations to perform classification, regression, or clustering, among other examples. Deployment in production environments facilitates automated decision-making, pattern recognition, and predictive analytics across various domains.

### SUMMARY

Some implementations described herein relate to a system for data analysis. The system may include one or more memories and one or more processors communicatively coupled to the one or more memories. The one or more processors may be configured to receive a request to generate a model adjustment factor for a data analysis model. The one or more processors may be configured to obtain, based on receiving the request, a first dataset of predictions associated with the data analysis model and a second dataset of actual outcomes associated with the first dataset of predictions. The one or more processors may be configured to identify, based on the first dataset and the second dataset, a performance gap associated with the data analysis model. The one or more processors may be configured to generate the model adjustment factor for the data analysis model based on the performance gap associated with the data analysis model, wherein the model adjustment factor is a scalar value applicable to one or more predictions associated with the data analysis model. The one or more processors may be configured to generate a data file for the data analysis model based on the model adjustment factor. The one or more processors may be configured to output the data file to a data structure, such that execution of the data analysis model causes the data analysis model to access the data file to use the model adjustment factor to adjust the one or more predictions associated with the data analysis model.

Some implementations described herein relate to a non-transitory computer-readable medium that stores a set of instructions. The set of instructions, when executed by one or more processors of a system, may cause the system to receive, via a user interface, a request to generate a model adjustment factor for a data analysis model. The set of instructions, when executed by one or more processors of the system, may cause the system to a generate at least one model adjustment factor for the data analysis model based on the performance gap associated with the data analysis model. The set of instructions, when executed by one or more processors of the system, may cause the system to generate a data file for the data analysis model based on the at least one model adjustment factor. The set of instructions, when executed by one or more processors of the system, may cause the system to output the data file to a data structure, such that execution of the data analysis model causes the data analysis model to access the data file to use the at least one model adjustment factor to adjust the one or more predictions associated with the data analysis model.

Some implementations described herein relate to a method for data analysis. The method may include detecting, by a device and based on a first dataset of predictions associated with a data analysis model and a second dataset of actual outcomes associated with the first dataset of predictions, a performance gap associated with the data analysis model. The method may include generating, by a device, a model adjustment factor for the data analysis model based on the performance gap associated with the data analysis model, wherein the model adjustment factor is a scalar value applicable to one or more predictions associated with the data analysis model. The method may include generating, by a device, a data file for the data analysis model based on the model adjustment factor. The method may include executing, by a device, the data analysis model with the data file to generate a third dataset of predictions associated with the data analysis model. The method may include outputting, by a device, information associated with the third set of predictions.

### BRIEF DESCRIPTION OF THE DRAWINGS

FIGS. 1A-1C are diagrams of an example implementation associated with data analysis model prediction adjustment using scalar factors, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with data analysis model prediction adjustment using scalar factors, in accordance with some embodiments of the present disclosure.

FIG. 4 is a flowchart of an example process associated with data analysis model prediction adjustment using scalar factors, in accordance with some embodiments of the present disclosure.

### DETAILED DESCRIPTION

The following detailed description of example implementations refers to the accompanying drawings. The same reference numbers in different drawings may identify the same or similar elements.

Systems may use many different artificial intelligence (AI) or machine learning (ML) (AI/ML) models to generate predictions regarding different datasets. For example, in a healthcare context, datasets may cover a wide variety of conditions, diseases, patient demographics, or treatment approaches, among other examples. Accordingly, a single AI/ML model may not be able to handle the different types of patient data and different types of predictive outputs. Accordingly, a healthcare prediction system may deploy different models for different conditions, different models for different treatment phases (e.g., diagnosis, prognosis, risk prediction, or treatment optimization), or different models for different types of patients (e.g., different models for children or adults), among other examples.

In a telecommunications context, different models may be used for different tasks, such as optimizing bandwidth usage, predicting network congestion, detecting anomalies, or generating device behavior predictions. Additionally, or alternatively, different models may be deployed for different regions, network technologies, or types of network equipment. In an agricultural context, different models may be deployed for generating predictions relating to different crop types or geographic locations, as well as for different tasks, such as pest prediction, crop disease diagnosis, yield forecasting, or irrigation optimization. In a financial context, an automobile loan provider may use different types of models to generate net present value determinations for auto loans. For example, different models may be applied to different types of vehicles, different credit score tiers of loan holders, or different types of intermediate determinations from which a net present value may be determined, such as predicting a loan risk assessment, predicting a likelihood of fraud, predicting a vehicle value (e.g., depreciation and residual value), or another type of determination.

In each context, among other examples, many different types of models may be used, such as logistic regression models, generalized linear models (GLMs), non-linear models, classifier models, or decision-tree models, among other examples. Different models may have different dataset sizes and complex model building workflows, which may include feature identification, data pipeline construction (e.g., for continuous data updating), model selection, dual control, or model impact analysis, among other examples. Accordingly, frequent model updating may be resource intensive in terms of processing resources, data storage resources, or network resources. Further, model updating may cause models to be unavailable for periods of time, which may result in incomplete prediction data at any one time. Accordingly, models may rarely be updated, which may result in models generating predictions that deviate from real world outcomes. Such deviations may increase over time, resulting in poor overall model prediction performance and negative impacts, such as negative patient outcomes, inefficient utilization of telecommunications network resources, poor crop performance, or inaccurate loan value determinations.

Some implementations described herein enable data analysis model prediction adjustment using scalar factors. For example, some implementations described herein may enable generation of a scalar model adjustment factor that can be applied to predictions being generated by a model to adjust the predictions to increase a prediction accuracy without performing model retraining. In some implementations, a data analysis system may generate model adjustment factors for many models, such as tens, hundreds, or thousands of models, being used by a system for prediction. By generating a scalar model adjustment factor, rather than performing model retraining, the data analysis system improves model prediction accuracy without excessive utilization of computing resources, such as processing resources, data storage resources, or network resources.

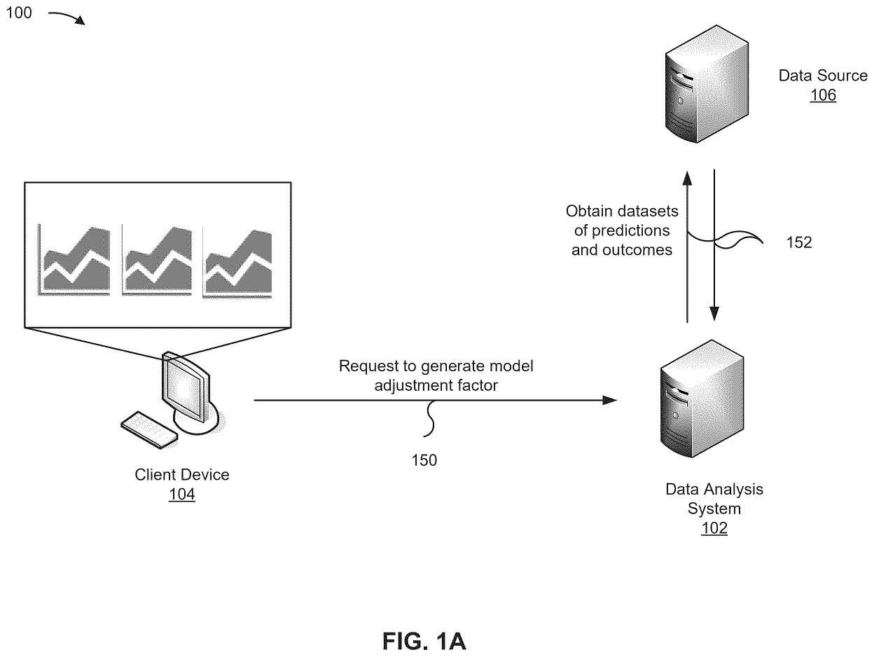

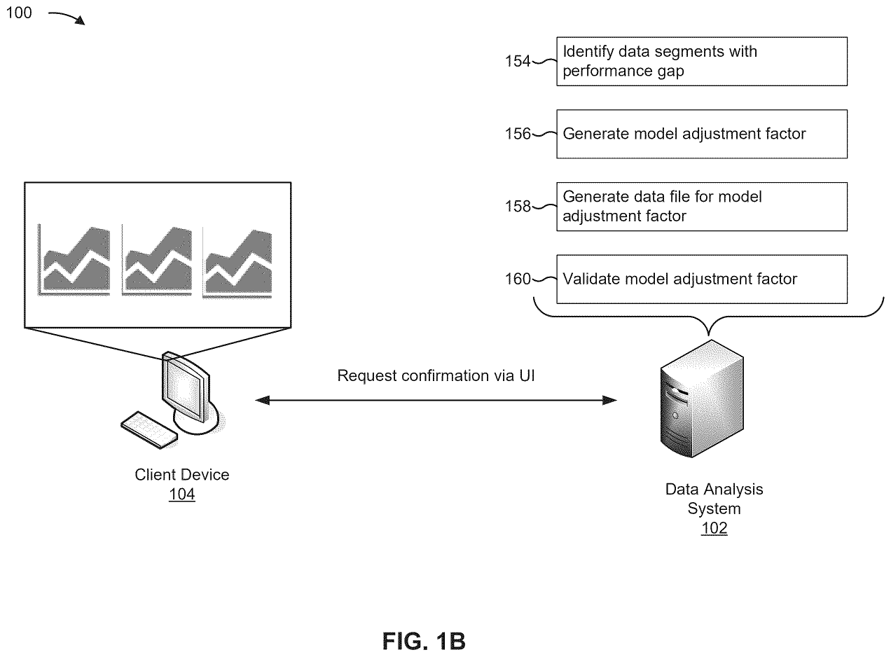

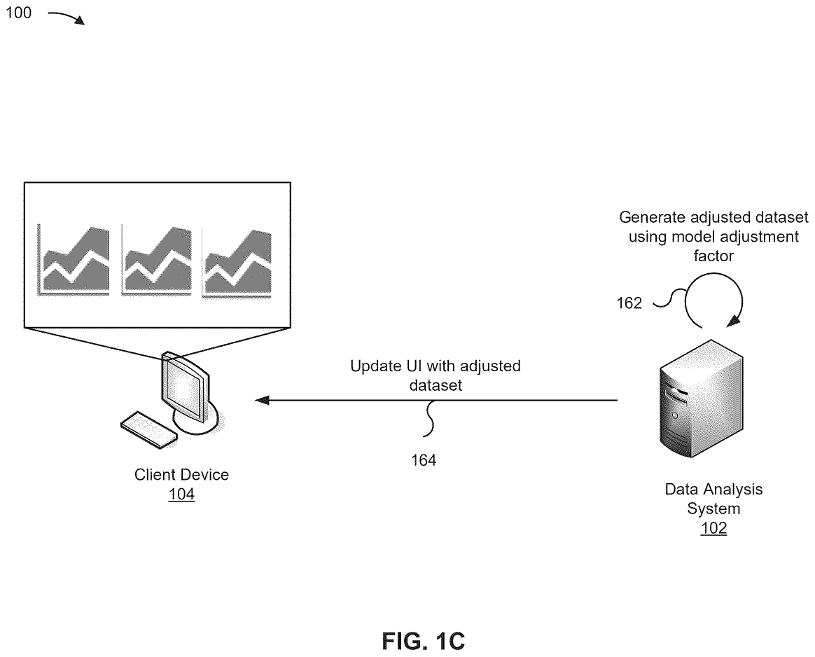

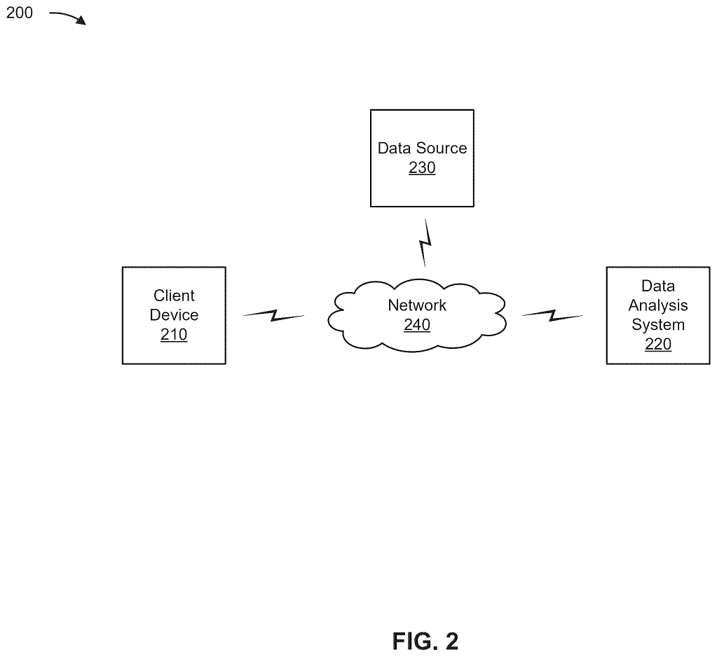

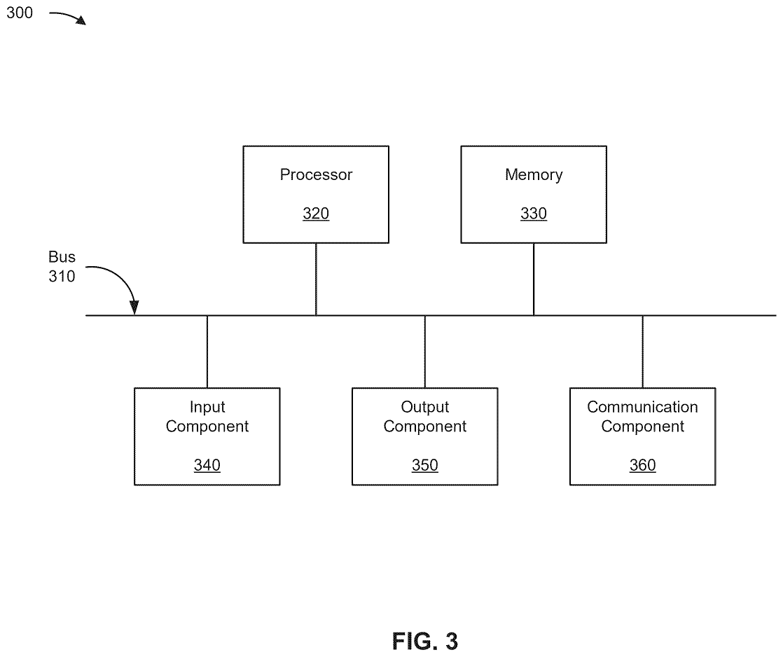

FIGS. 1A-1C are diagrams of an example implementation 100 associated with data analysis model prediction adjustment using scalar factors. As shown in FIGS. 1A-1C, example implementation 100 includes a data analysis system 102, a client device 104, and a data source 106. These devices are described in more detail below in connection with FIG. 2 and FIG. 3.

As shown in FIG. 1A, and by reference number 150, the data analysis system 102 may receive a request to generate a model adjustment factor. For example, the data analysis system 102 may receive a request to generate a model adjustment factor from the client device 104. In some implementations, the client device 104 may provide a user interface that includes information relating to predictions generated by a set of data analysis models, such as tens, hundreds, or thousands of models. As described above, the data analysis models may be related to generating predictions in a healthcare context, a telecommunications context, an agricultural context, or a financial context, among other examples. Accordingly, the client device 104 may provide real-time information relating to an output of the data analysis models, such as real-time information identifying patient predictions, telecommunications network parameter selections, crop watering predictions, or automobile loan value predictions. In this case, a user of the client device 104 may interact with the user interface to trigger model adjustment, such as based on an output being provided via the user interface.

Additionally, or alternatively, the data analysis system 102 may periodically trigger generation (or updating) of a model adjustment factor. For example, the data analysis system 102 may trigger generation of a model adjustment factor in accordance with a configured periodicity, such as on a weekly basis, a monthly basis, or a yearly basis. Additionally, or alternatively, the data analysis system 102 may trigger generation of the model adjustment factor based on an occurrence of an event. For example, when the data analysis system 102 determines that an output of a data analysis model satisfies one or more selection criteria, such as being of a configured type, a configured value, a configured deviance from another value, or another criterion, the data analysis system 102 may trigger generation of a model adjustment factor.

Additionally, or alternatively, the data analysis system 102 may trigger generation (or updating) of a model adjustment factor based on analyzing model performance. For example, as described in more detail herein, the data analysis system 102 may monitor an output of a data analysis model, of a set of data analysis models being executed in connection with the data analysis system, and may determine that the output of the data analysis mode is associated with a threshold performance gap. In other words, the data analysis system 102 may compare a set of predictions generated by the data analysis model with actual outcomes for which the predictions were generated and may determine that the predictions deviate from the actual outcomes by at least a configured amount or percentage. In some implementations, the data analysis system 102 may trigger generation of a model adjustment factor for a particular type of data analysis model. For example, the data analysis system 102 may trigger generation of a model adjustment factor for a logistic regression model, a GLM model, or a non-linear model.

As further shown in FIG. 1A, and by reference number 152, the data analysis system 102 may obtain one or more datasets relating to data analysis model predictions or actual outcomes relating to the predictions, among other examples. In some implementations, the data analysis system 102 may obtain the one or more datasets from the data source 106. For example, the data analysis system 102 may request data from the data source 106 by transmitting a request message and may receive the data from the data source 106 via a response message.

In some implementations, the data analysis system 102 may obtain a first dataset of predictions generated using one or more data analysis models. Additionally, or alternatively, the data analysis system 102 may obtain a second dataset of actual outcomes relating to the predictions generated by the one or more data analysis models. As an example, in a healthcare context, the data analysis system 102 may obtain a first dataset of predicted pre-testing diagnoses and a second dataset of post-testing confirmations or rejections of the diagnoses. Additionally, or alternatively, the data analysis system 102 may receive a first dataset of predicted prognoses and a second dataset of follow-up health surveys indicating whether the predicted prognoses were correct or incorrect. Similarly, in a telecommunications context, the data analysis system 102 may receive a first dataset identifying a set of parameter selections and a second dataset identifying network traffic resulting from the set of parameter selections. Similarly, in an agricultural context, the data analysis system 102 may receive a first dataset identifying predicted crop yields of a set of crops and a second dataset identifying actual crop yields over a period of time. Similarly, in a financial context, the data analysis system 102 may receive a first dataset identifying predicted resale values of used cars and may receive a second dataset identifying actual resale values for the used cars.

As shown in FIG. 1B, and by reference number 154, the data analysis system 102 may identify one or more data segments associated with a performance gap. For example, the data analysis system 102 may identify data segments for which a predicted value deviates from an actual outcome by a threshold amount. A data segment may include a data analysis model or a subset of predictions thereof. For example, in a healthcare context, the data analysis system 102 may determine that predictions generated by a diagnosis model for kidney disease deviate from actual outcomes by a threshold amount. Additionally, or alternatively, the data analysis system 102 may determine that a subset of predictions, such as kidney disease predictions for a particular age range (e.g., patients 18-35 or 50-70), deviate from actual outcomes by the threshold amount (but that other subsets of predictions do not deviate from actual outcomes by the threshold amount). Similarly, in a financial context, the data analysis system 102 may determine that a subset of auto loan value predictions related to leased vehicles deviate by a threshold amount, but that another subset of loan value predictions related to purchased vehicles do not deviate by the threshold amount.

In some implementations, the data analysis system 102 may generate a set of performance gap tests for determining a performance gap. For example, the data analysis system 102 may use a machine learning model (e.g., a decision-tree model, such as XGBoost) to generate a performance gap test of prediction data versus actual outcome data to determine whether a data analysis model under test deviates, in prediction output, from actual outcomes. The data analysis system 102 may identify a performance gap test that satisfies a set of selection criteria. For example, the data analysis system 102 may identify a subset of predictions, subject to an evaluation of prediction data versus actual outcome data, that deviates from actual outcomes by at least a threshold amount. Additionally, or alternatively, the data analysis system 102 may identify a subset of predictions for which a confidence interval does not result in a configured accuracy level. Additionally, or alternatively, the data analysis system 102 may determine that an amount of deviation of predictions relative to actual outcomes is less than a threshold amount. In other words, when there is a large standard deviation in an amount by which predictions deviate from actual outcomes, a scalar adjustment factor based on a mean deviation of the predictions may not improve accuracy by a desired amount. In contrast, when the standard deviation in the amount by which predictions deviate from actual outcomes is very small, a scalar adjustment factor based on the mean deviation of the predictions may result in a relatively large accuracy improvement.

In some implementations, the data analysis system 102 may communicate with the client device 104 to request confirmation via a user interface (UI) with regard to identifying data segments with a performance gap (or with regard to one or more other operations described herein). For example, when the data analysis system 102 identifies a candidate set of data segments with performance gaps, the data analysis system 102 may transmit information derived from the candidate set of data segments and may receive a selection of one or more data segments for which to generate model adjustment factors. Similarly, as described in more detail herein, the data analysis system 102 may request confirmation of one or more generated model adjustment factors or confirmation of validation of a data analysis model to which a model adjustment factor is applied, among other examples.

As further shown in FIG. 1B, and by reference number 156, the data analysis system 102 may generate a model adjustment factor. For example, the data analysis system 102 may determine one or more scalar values to apply to outputs from a selected data analysis model that is associated with a performance gap. In some implementations, the data analysis system 102 may generate one or more different types of model adjustment factors. For example, the data analysis system 102 may generate an adjustment scalar or a conservatism scalar, among other examples.

An adjustment scalar may include a numerical value that is mathematically applied to an output of a data analysis model to alter the output of the data analysis model. For example, in the context of an agricultural yield determination, the data analysis system 102 may determine an adjustment scalar that increases yield predictions by a particular percentage. Similarly, in the context of an auto loan valuation, the data analysis system 102 may determine an adjustment scalar that decreases a value prediction by a fixed amount. In this case, the data analysis system 102 may determine the adjustment scalar based on processing a deviation between a set of predicted outcomes and a set of actual outcomes. For example, the data analysis system 102 may determine that yield predictions under-predict actual outcomes by, on average, the particular percentage and may select the particular percentage as the adjustment scalar. Similarly, the data analysis system 102 may determine that loan valuations are higher than actual value determinations by, on average, a particular amount, which the data analysis system 102 may select as the adjustment scalar.

A conservatism scalar may include a risk value that is applied to determine a predicted accuracy of an output of a data analysis model to alter an interpretation of the output of the data analysis model. For example, when a data analysis model is configured to provide an output with a 99% accuracy confidence, but the data analysis system 102 determines that an actual accuracy of the output of the data analysis model is a 95% accuracy, the data analysis system 102 may determine a conservatism scalar that decreases the accuracy confidence from 99% to 95%. Additionally, or alternatively, the data analysis system 102 may adjust another statistical metric relating to the confidence, such as by changing a size of a confidence interval. In this case, subsequent calculations, performed by the data analysis system 102, may use the adjusted confidence interval or adjusted accuracy confidence, thereby resulting in changes to final outputs, changes to automatic actions that are triggered, or other changes.

In some implementations, the data analysis system 102 may generate model adjustment factors for a plurality of models. For example, the data analysis system 102 may analyze tens, hundreds, or thousands of data analysis models with a performance gap and may generate model adjustment factors to improve an accuracy of the data analysis models without re-training the data analysis models. Additionally, or alternatively, the data analysis system 102 may generate a plurality of model adjustment factors for a single data analysis model. For example, the data analysis system 102 may generate an adjustment scalar and a conservatism scalar for a data analysis model. In this case, the conservatism scalar may be related to the adjustment scalar (e.g., a larger value of the adjustment scalar may relate to a lower confidence value for the conservatism scalar). Additionally, or alternatively, the data analysis system 102 may generate a first model adjustment factor for a first portion of a data analysis model (e.g., a first subset of inputs or outputs) and a second model adjustment factor for a second portion of the data analysis model (e.g., a second subset of inputs or outputs). For example, in a healthcare context, the data analysis system 102 may generate a first model adjustment factor for patients in a first age range and a second model adjustment factor for patients in a second age range based on a data analysis model having different performance gaps for the first age range and the second age range. Additionally, or alternatively, in a loan value context, the data analysis system 102 may generate a first model adjustment factor for a first make of vehicle and a second model adjustment factor for a second make of vehicle.

As further shown in FIG. 1B, and by reference number 158, the data analysis system 102 may generate a data file for the model adjustment factor. For the example, the data analysis system 102 may generate a model specification file that can be used in execution of a data analysis model to which the model adjustment factor is applicable. The model specification file may identify one or more properties or parameters for the data analysis model to use when executing to generate a prediction. For example, the data analysis system 102 may generate a JavaScript Object Notation (JSON) file that is executable or accessible in connection with the data analysis model, such that when the data analysis model is used to generate a prediction, the model adjustment factor is applied as part of a request for generation of the prediction.

As further shown in FIG. 1B, and by reference number 160, the data analysis system 102 may validate the model adjustment factor. For example, the data analysis system 102 may determine a new performance gap for a data analysis model when using the model adjustment factor. In this case, the data analysis system 102 may execute the data analysis model to generate a set of predictions, using the data file of the model adjustment factor to apply the model adjustment factor to the set of predictions, and may evaluate whether a performance gap for the data analysis model with the model adjustment factor is less than the performance gap for the data analysis model without the model adjustment factor. Accordingly, based on determining that the model adjustment factor improves an accuracy score of the data analysis model (or a portion thereof) (e.g., by at least a threshold amount), the data analysis system 102 may validate the model adjustment factor.

As shown in FIG. 1C, and by reference number 162, the data analysis system 102 may generate an adjusted dataset using the model adjustment factor. For example, the data analysis system 102 may generate a dataset using a data analysis model with the model adjustment factor applied and may generate one or more data visualizations using the dataset. In this case, the data analysis system 102 updates a user interface with which a user of a client device 104 can view outputs from a set of data analysis models.

As further shown in FIG. 1C, and by reference number 164, the data analysis system 102 may output information associated with the model adjustment factor. For example, the data analysis system 102 may output a user interface, with data visualizations of a dataset generated using a data analysis model with a model adjustment factor, for display via the client device 104. In some implementations, the data analysis system 102 may include, in a monitoring dashboard user interface, data visualizations relating to a first dataset of predictions, a second dataset of actual outcomes, or a third dataset of adjustment predictions associated with the model adjustment factor.

Additionally, or alternatively, the data analysis system 102 may perform one or more automated actions or trigger one or more automated actions. For example, based on an output of a data analysis model with a model adjustment factor applied, the data analysis system 102 may trigger one or more configured actions to which the output corresponds. Examples of automated actions may include, automatic prescribing of medication or treatments in a healthcare context, automatic adjustment of watering schedules in an agricultural context, automatic approval of automobile loans in a loan valuation context, or automatic adjustment of telecommunications network parameters in a telecommunications network operation context, among other examples.

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

FIG. 2 is a diagram of an example environment 200 in which systems and/or methods described herein may be implemented. As shown in FIG. 2, environment 200 may include a client device 210, a data analysis system 220, a data source 230, and a network 240. Devices of environment 200 may interconnect via wired connections, wireless connections, or a combination of wired and wireless connections.

The client device 210 may include one or more devices capable of receiving, generating, storing, processing, and/or providing information associated with data analysis model prediction adjustment using scalar factors, as described elsewhere herein. The client device 210 may include a communication device and/or a computing device. For example, the client device 210 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The data analysis system 220 may include one or more devices capable of receiving, generating, storing, processing, providing, and/or routing information associated with data analysis model prediction adjustment using scalar factors, as described elsewhere herein. The data analysis system 220 may include a communication device and/or a computing device. For example, the data analysis system 220 may include a server, such as an application server, a client server, a web server, a database server, a host server, a proxy server, a virtual server (e.g., executing on computing hardware), or a server in a cloud computing system. In some implementations, the data analysis system 220 may include computing hardware used in a cloud computing environment, such as one or more serverless components (e.g., one or more serverless functions), among other examples.

The data source 230 may include one or more devices capable of receiving, generating, storing, processing, and/or providing information associated with data analysis model adjustment, as described elsewhere herein. The data source 230 may include a communication device and/or a computing device. For example, the data source 230 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data source 230 may communicate with one or more other devices of environment 200, as described elsewhere herein.

The network 240 may include one or more wired and/or wireless networks. For example, the network 240 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with data analysis model prediction adjustment using scalar factors. The device 300 corresponds to one or more of client device 210, data analysis system 220, and/or data source 230. In some implementations, client device 210, data analysis system 220, and/or data source 230 include one or more devices 300 and/or one or more components of the device 300. In the example shown in FIG. 3, the device 300 includes a bus 310, a processor 320, a memory 330, an input component 340, an output component 350, and/or a communication component 360.

The bus 310 includes one or more components that enable wired and/or wireless communication among the components of the device 300. The bus 310 couples together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 includes a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory, such as random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). In some implementations, the memory 330 is a non-transitory computer-readable medium. The memory 330 stores information, one or more instructions, and/or software (e.g., one or more software applications) related to the operation of the device 300. In some implementations, the memory 330 includes one or more memories that are coupled (e.g., communicatively coupled) to one or more processors (e.g., processor 320), such as via the bus 310. Communicative coupling between a processor 320 and a memory 330 enables the processor 320 to read and/or process information stored in the memory 330 and/or to store information in the memory 330.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

In some implementations, the device 300 performs one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

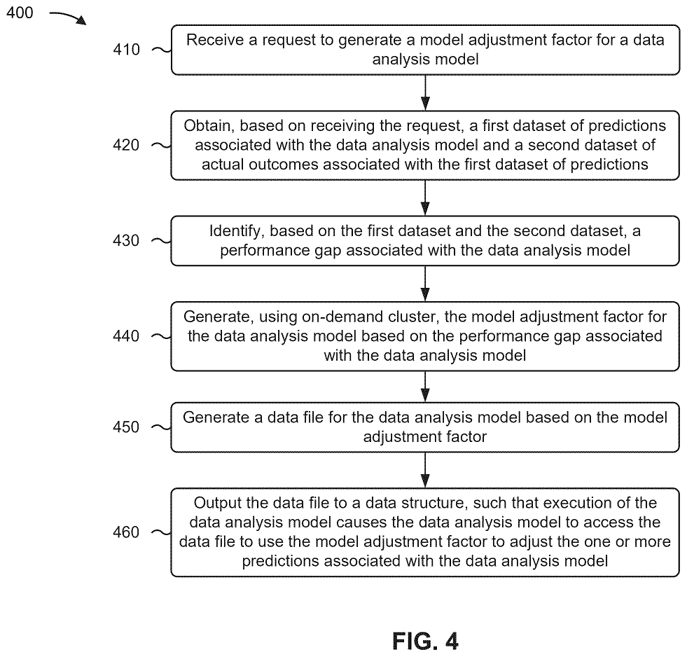

FIG. 4 is a flowchart of an example process 400 associated with data analysis model prediction adjustment using scalar factors. In some implementations, one or more process blocks of FIG. 4 may be performed by the data analysis system 220. In some implementations, one or more process blocks of FIG. 4 may be performed by another device or a group of devices separate from or including the data analysis system 220, such as the client device 210 and/or the data source 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving a request to generate a model adjustment factor for a data analysis model (block 410). For example, the data analysis system 220 (e.g., using processor 320, memory 330, input component 340, and/or communication component 360) may receive a request to generate a model adjustment factor for a data analysis model, as described above in connection with reference number 150 of FIG. 1A. As an example, the data analysis system 220 may determine that a set of predicted results of executing the data analysis model deviate from an actual set of results by a threshold amount, thereby triggering model adjustment.

As further shown in FIG. 4, process 400 may include obtaining, based on receiving the request, a first dataset of predictions associated with the data analysis model and a second dataset of actual outcomes associated with the first dataset of predictions (block 420). For example, the data analysis system 220 (e.g., using processor 320 and/or memory 330) may obtain, based on receiving the request, a first dataset of predictions associated with the data analysis model and a second dataset of actual outcomes associated with the first dataset of predictions, as described above in connection with reference number 152 of FIG. 1A. As an example, the data analysis system 220 may obtain datasets identifying predictions and actual outcomes for analysis.

As further shown in FIG. 4, process 400 may include identifying, based on the first dataset and the second dataset, a performance gap associated with the data analysis model (block 430). For example, the data analysis system 220 (e.g., using processor 320 and/or memory 330) may identify, based on the first dataset and the second dataset, a performance gap associated with the data analysis model, as described above in connection with reference number 154 of FIG. 1B. As an example, the data analysis system 220 may determine that a performance of the data analysis model satisfies one or more criteria for model adjustment.

As further shown in FIG. 4, process 400 may include generating, using an on-demand cluster, the model adjustment factor for the data analysis model based on the performance gap associated with the data analysis model (block 440). For example, the data analysis system 220 (e.g., using processor 320 and/or memory 330) may generate the model adjustment factor for the data analysis model based on the performance gap associated with the data analysis model, wherein the model adjustment factor is a scalar value applicable to one or more predictions associated with the data analysis model, as described above in connection with reference number 156 of FIG. 1B. As an example, the data analysis system 220 may determine a scalar value that adjusts model results such that a predictive accuracy of the model results is improved. In some implementations, the model adjustment factor is a scalar value applicable to one or more predictions associated with the data analysis model. The data analysis system 220 may, based on a request for scalar adjustment, trigger a step function to orchestrate a scalar adjustment generation process. The data analysis system 220 may initiate an on-demand data processing cluster with auto-scaling capability to optimize resource utilization. The data analysis system 220 may install an engine on a cluster to compute account level valuations. The data analysis system 220 analyzes the valuations to determine a gap between actual values and predicted values and to generate one or more scalar adjustment factors based on the gap. Based on the data analysis system 220 having completed one or more calculations, the data analysis system 220 may terminate the data processing cluster, ensuring cost efficiency by only utilizing compute resources when needed.

As further shown in FIG. 4, process 400 may include generating a data file for the data analysis model based on the model adjustment factor (block 450). For example, the data analysis system 220 (e.g., using processor 320 and/or memory 330) may generate a data file for the data analysis model based on the model adjustment factor, as described above in connection with reference number 158 of FIG. 1B. As an example, the data analysis system 220 may generate a JSON file that is executable with the data analysis model to cause predictions of the data analysis model to be adjusted by the model adjustment factor.

As further shown in FIG. 4, process 400 may include outputting the data file to a data structure, such that execution of the data analysis model causes the data analysis model to access the data file to use the model adjustment factor to adjust the one or more predictions associated with the data analysis model (block 460). For example, the data analysis system 220 (e.g., using processor 320, memory 330, and/or output component 350) may output the data file to a data structure, such that execution of the data analysis model causes the data analysis model to access the data file to use the model adjustment factor to adjust the one or more predictions associated with the data analysis model, as described above in connection with reference number 164 of FIG. 1C. As an example, the data analysis system 220 may output the model adjustment factor, the data file that is executable to cause the model adjustment factor to be applied, and/or a set of results of executing the data analysis model with the model adjustment factor applied.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1C. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for data analysis, the system comprising:
one or more memories; and
one or more processors, communicatively coupled to the one or more memories, configured to:
receive a request to generate a model adjustment factor for a data analysis model;
obtain, based on receiving the request, a first dataset of predictions associated with the data analysis model and a second dataset of actual outcomes associated with the first dataset of predictions;
identify, based on the first dataset and the second dataset, a performance gap associated with the data analysis model;
generate the model adjustment factor for the data analysis model based on the performance gap associated with the data analysis model,
wherein the model adjustment factor is a scalar value applicable to one or more predictions associated with the data analysis model;
generate a data file for the data analysis model based on the model adjustment factor; and
output the data file to a data structure, such that execution of the data analysis model causes the data analysis model to access the data file to use the model adjustment factor to adjust the one or more predictions associated with the data analysis model.

2. The system of claim 1, wherein the one or more processors, to identify the performance gap, are configured to:
generate a set of performance gap tests using a machine learning model;
identify a performance gap test, of the set of performance gap tests, that satisfies a set of selection criteria; and
identify the performance gap based on the performance gap test satisfying the set of selection criteria.

3. The system of claim 2, wherein the machine learning model includes a decision-tree based model.

4. The system of claim 1, wherein the model adjustment factor includes at least one of:
an adjustment scalar, or
a conservatism scalar.

5. The system of claim 1, wherein the data file is a model specification file identifying one or more properties for the data analysis model.

6. The system of claim 1, wherein the data file is associated with a JavaScript Object Notation (JSON) format.

7. The system of claim 1, wherein the one or more processors are further configured to:
generate a first accuracy score for the data analysis model without using the model adjustment factor;
generate a second accuracy score for the data analysis model using the model adjustment factor; and
validate the model adjustment factor based on the second accuracy score being higher than the first accuracy score; and
wherein the one or more processors, to output the data file, are configured to:
output the data file based on validating the model adjustment factor.

8. A non-transitory computer-readable medium storing a set of instructions, the set of instructions comprising:
one or more instructions that, when executed by one or more processors of a system, cause the system to:
receive, via a user interface, a request to generate a model adjustment factor for a data analysis model;
obtain, based on receiving the request, a first dataset of predictions associated with the data analysis model and a second dataset of actual outcomes associated with the first dataset of predictions;
determine, based on the first dataset and the second dataset, that a performance gap associated with the data analysis model satisfies a set of criteria;
generate at least one model adjustment factor for the data analysis model based on the performance gap associated with the data analysis model;
generate a data file for the data analysis model based on the at least one model adjustment factor; and
output the data file to a data structure, such that execution of the data analysis model causes the data analysis model to access the data file to use the at least one model adjustment factor to adjust the one or more predictions associated with the data analysis model.

9. The non-transitory computer-readable medium of claim 8, wherein the one or more instructions further cause the system to:
provide, via the user interface, information relating to execution of the data analysis model,
wherein the information relating to the execution of the data analysis model includes information derived from at least a portion of the first dataset of predictions; and
wherein the one or more instructions, that cause the system to receive the request to generate the at least one model adjustment factor, cause the system to:
receive the request to generate the at least one model adjustment factor via the user interface.

10. The non-transitory computer-readable medium of claim 8, wherein the one or more instructions further cause the system to:
provide, via the user interface, information relating to identifying a data segment associated with the performance gap; and
receive, via the user interface, information identifying a selection of the data segment associated with the performance gap.

11. The non-transitory computer-readable medium of claim 8, wherein the one or more instructions further cause the system to:
provide, via the user interface, a preview of the data file; and
receive, via the user interface, a confirmation of the data file; and
wherein the one or more instructions, that cause the system to output the data file to the data structure, cause the system to:
output the data file to the data structure based on receiving the confirmation of the data file.

12. The non-transitory computer-readable medium of claim 8, wherein the one or more instructions further cause the system to:
provide, via the user interface, information identifying the at least one model adjustment factor, wherein the information includes a set of updated predictions incorporating the model adjustment factor into an output of the data analysis model; and
receive, via the user interface, a confirmation of the at least one model adjustment factor; and
wherein the one or more instructions, that cause the system to output the data file to the data structure, cause the system to:
output the data file to the data structure based on receiving the confirmation of the at least one model adjustment factor.

13. The non-transitory computer-readable medium of claim 8, wherein the one or more instructions further cause the system to:
provide, via the user interface, a monitoring dashboard identifying a real-time output from the data analysis model.

14. The non-transitory computer-readable medium of claim 13, wherein the monitoring dashboard includes information identifying at least one of:
the first dataset of predictions,
the second dataset of actual outcomes, or
a third dataset of adjusted predictions associated with the model adjustment factor.

15. The non-transitory computer-readable medium of claim 8, wherein the one or more instructions, that cause the system to determine that the performance gap satisfies one or more criteria, cause the system to:
evaluate a plurality of data analysis models to identify the performance gap; and
identify the data analysis model, of the plurality of data analysis models, that satisfies the one or more criteria for the performance gap.

16. A method for data analysis, comprising:
detecting, by a device and based on a first dataset of predictions associated with a data analysis model and a second dataset of actual outcomes associated with the first dataset of predictions, a performance gap associated with the data analysis model;
generating, by a device, a model adjustment factor for the data analysis model based on the performance gap associated with the data analysis model,
wherein the model adjustment factor is a scalar value applicable to one or more predictions associated with the data analysis model;
generating, by a device, a data file for the data analysis model based on the model adjustment factor;
executing, by a device, the data analysis model with the data file to generate a third dataset of predictions associated with the data analysis model; and
outputting, by a device, information associated with the third set of predictions.

17. The method of claim 16, wherein detecting the performance gap comprises:
automatically generating a set of performance gap tests using a machine learning model;
identifying a performance gap test, of the set of performance gap tests, that satisfies a set of selection criteria; and
identifying the performance gap based on the performance gap test satisfying the set of selection criteria.

18. The method of claim 17, wherein the machine learning model includes a decision-tree based model.

19. The method of claim 16, wherein the model adjustment factor includes at least one of:
an adjustment scalar, or
a conservatism scalar.

20. The method of claim 16, further comprising:
generating a first accuracy score for the data analysis model without using the model adjustment factor;
generating a second accuracy score for the data analysis model using the model adjustment factor; and
validating the model adjustment factor based on the second accuracy score being higher than the first accuracy score; and
wherein outputting the third dataset comprises:
outputting the data file based on validating the model adjustment factor.
